(19) United States
(12) Patent Application Publication
(10) Pub. No.: US 2015/0116120 A1
(43) Pub. Date: Apr. 30, 2015

(54) MOTION MONITORING DEVICE

(71) Applicant: Seiko Epson Corporation, Tokyo (JP)

(72) Inventor: Jun WATANABE, Matsumoto (JP)

(21) Appl. No.: 14/506,947

(22) Filed: Oct. 6, 2014

(30) Foreign Application Priority Data
Oct. 28, 2013 (JP) 2013-223007

(51) Int. Cl. G08B 21/18

(52) U.S. Cl. CPC G08B 21/18
USPC 340/669

(57) ABSTRACT

A motion monitoring device includes a detection section attached to a test subject, and adapted to detect a motion of the test subject, a determination section adapted to determine whether or not displacement information of the test subject obtained based on a detection data from the detection section exceeds a threshold value, and an announcement section adapted to make an announcement to the test subject based on the determination.

### BACKGROUND

1. Technical Field

The present invention relates to a motion monitoring device.

2. Related Art

In the past, there have been provided a variety of devices each for detecting a physical motion using a sensor. For example, in JP-A-2008-272336 (Document 1), there is proposed a Zazen game machine, which detects a motion of a person in Zazen meditation using a pedestal (a floor cushion) provided with a detector and gives a stimulus or a warning to the person in Zazen based on the detection result.

However, the Zazen game machine proposed in Document 1 is provided with a pedestal on which the person in Zazen meditation can be seated, and a hitting device for providing a caution to the person in Zazen meditation, or provided with a floor cushion on which the person in Zazen meditation can be seated, and therefore, becomes large in scale as a device. Further, since a work such as assembling of the device is necessary before starting the Zazen game, there is a problem of lacking usability.

### SUMMARY

An advantage of some aspects of the invention is to solve at least a part of the problems described above, and the invention can be implemented as the following forms or application examples.

### APPLICATION EXAMPLE 1

This application example is directed to a motion monitoring device including an acceleration detection section adapted to detect acceleration, and then output a detection data, an operation section adapted to calculate displacement information using the detection data, a determination section adapted to determine whether a motion is present or absent based on the displacement information, an announcement signal output section adapted to transmit an announcement signal to the announcement section based on the determination, and an announcement device adapted to make an announcement to the test subject based on the announcement signal received. Another aspect of the invention is directed to a motion monitoring device including a detection section attached to a test subject, and adapted to detect a motion of the test subject, a determination section adapted to determine whether or not displacement information of the test subject measured based on a detection data from the detection section exceeds a threshold value, and an announcement section adapted to make an announcement to the test subject based on the determination. In still another aspect of the invention, the motion monitoring device includes an announcement signal output section adapted to transmit an announcement signal to the announcement section based on a determination result from the determination section, and the announcement section makes an announcement to the test subject based on the announcement signal. In yet another aspect of the invention, the motion monitoring device includes an operation section adapted to calculate the displacement information based on acceleration, the detection section is capable of detecting acceleration, and the operation section calculates the displacement information of the test subject based on the acceleration detected by the detection section.

According to such motion monitoring devices, there are included, for example, the detection section, the determination section, and the announcement section, and the acceleration of the test subject is detected in the detection section. The determination section determines the motion of the test subject using the displacement information converted based on the acceleration, and the announcement section can make an announcement to the test subject based on the determination. Thus, the motion monitoring device is capable of monitoring the motion and then making an announcement with constituents small in size and number, and can therefore be reduced in size, provided with portability, and improved in convenience.

### APPLICATION EXAMPLE 2

This application example is directed to the motion monitoring device according to the application example described above, wherein the determination section determines whether the motion is present or absent based on whether or not the displacement information exceeds a threshold value.

According to such a motion monitoring device, by determining whether the motion is present or absent based on whether or not the displacement information exceeds the predetermined threshold value using the determination section, and making an announcement based on the determination using the announcement device, it becomes easy to detect the motion, and it becomes possible to make it easier to monitor the motion.

### APPLICATION EXAMPLE 3

This application example is directed to the motion monitoring device according to the application example described above, wherein the determination section determines whether the motion is present or absent based on whether or not the displacement information is the same as the displacement information having previously been measured.

According to such a motion monitoring device, by determining whether the motion is present or absent based on whether or not the displacement information is the same as the displacement information having previously been measured using the determination section, and making an announcement based on the determination using the announcement device, it becomes easy to detect the motion, and it becomes possible to make it easier to monitor the motion.

### APPLICATION EXAMPLE 4

This application example is directed to the motion monitoring device according to the application example described above, wherein the acceleration detection section is mounted on at least one of the test subject and clothing worn by the test subject.

According to such a motion monitoring device, since the acceleration detection section is mounted on at least one of the test subject and the clothing worn by the test subject, the acceleration of the test subject can be detected, and whether the motion is present or absent can be announced to the test subject. Thus, the motion monitoring device is capable of monitoring the motion and then making an announcement with constituents small in size and number, and can therefore be reduced in size, provided with portability, and improved in convenience.

### APPLICATION EXAMPLE 5

This application example is directed to the motion monitoring device according to the application example described above, wherein the operation section integrates the detection data twice to calculate the displacement information, and the determination section determines whether the motion is present or absent based on whether or not the displacement information exceeds a threshold value.

According to such a motion monitoring device, the operation section integrates the detection data twice to thereby convert the detection data into the displacement information. By determining whether the motion is present or absent based on whether or not the displacement information exceeds the predetermined threshold value, and making an announcement based on the determination using the announcement device, it becomes easy to detect the motion, and it becomes possible to make it easier to monitor the motion.

### BRIEF DESCRIPTION OF THE DRAWINGS

The invention will be described with reference to the accompanying drawings, wherein like numbers reference like elements.

FIG. 1 is a diagram showing a configuration example of a motion monitoring device according to a first embodiment of the invention.

FIG. 2 is a diagram showing a configuration example of a sensor section of the first embodiment.

FIG. 3 is a diagram showing a configuration example of an information processing section of the first embodiment.

FIGS. 4A and 4B are diagrams each showing an example of displacement information of the sensor section of the first embodiment.

FIG. 5 is a diagram showing a configuration example of an announcement section of the first embodiment.

FIGS. 6A, 6B, and 6C are flowcharts showing an example of a process of the motion monitoring device according to the first embodiment.

FIG. 7 is a diagram showing an example of a worn item attached with the sensor section of the first embodiment.

FIG. 8 is a diagram showing a configuration example of a motion monitoring device according to a second embodiment of the invention.

FIGS. 9A and 9B are diagrams showing a configuration example of a motion monitoring device according to a third embodiment of the invention.

FIG. 10 is a diagram showing a configuration example of a motion monitoring device according to a modified example.

FIG. 11A is a plan view showing a configuration example of an acceleration detection section, and FIG. 11B is a cross-sectional view showing a configuration example of the acceleration detection section.

### DESCRIPTION OF EXEMPLARY EMBODIMENTS

Some embodiments of the invention will hereinafter be explained with reference to the accompanying drawings. It should be noted that in each of the drawings described below, the scale sizes of the layers and the members are made different from the actual dimensions in order to make the layers and the members have recognizable dimensions.

### First Embodiment

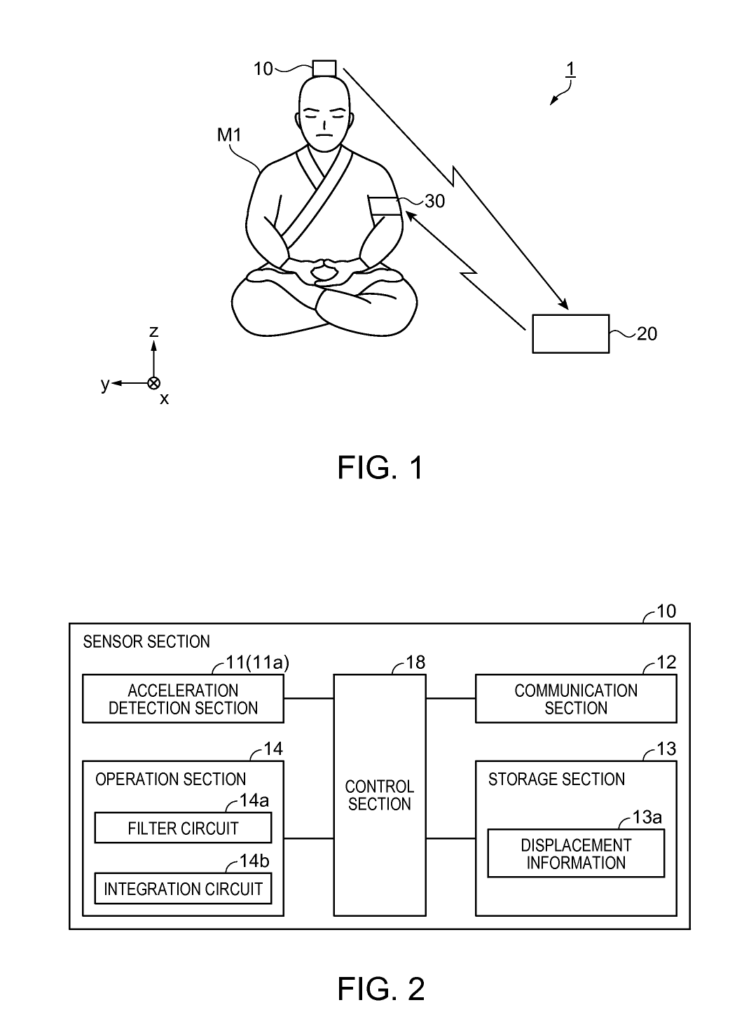

A schematic configuration of a motion monitoring device according to the present embodiment will be explained. FIG. 1 is a diagram showing a configuration example of the motion monitoring device 1 according to the present embodiment. In FIG. 1, an x axis, a y axis, and a z axis are shown as three axes perpendicular to each other.

The motion monitoring device 1 is configured including a sensor section 10 attached to the head of the user M1 in a state in which the user M1 as a test subject is seated, an information processing section 20, and an announcement section 30 attached to an arm of the user M1.

The information processing section 20 can be connected to the sensor section 10 and the announcement section 30 with wireless communication via communication sections 12, 22, and 32 (see FIGS. 2, 3, and 5), and can receive data transmitted from the sensor section 10. Further, the announcement section 30 can receive data transmitted from the information processing section 20. It should be noted that the connection between the sensor section 10 and the information processing section 20, and the connection between the announcement section 30 and the information processing section 20 are not limited to the wireless communication.

The position of the sensor section 10 attached to the user M1 is not limited to the head, but can also be, for example, the lumbar, the chest, or a worn item (clothing) of the user M1. Further, the position of the announcement section 30 attached to the user M1 is not limited to the arm, but can also be, for example, the head, the neck, or the worn item of the user M1.

Although in the present embodiment, the sensor section 10 is attached to the user M1, it is sufficient for the sensor section 10 to be attached to at least (either) one of the user M1 and the worn item of the user M1.

In the motion monitoring device 1, a motion (acceleration) of the user M1 is detected using the sensor (an acceleration detection section 11 (FIG. 2)) provided to the sensor section 10, and then the detection data thus detected is transmitted to the information processing section 20. Then, the information processing section 20 determines whether the motion of the user M1 is present or absent based on the detection data received, and then displays the motion of the user M1 on, for example, a display, or transmits an announcement signal to the announcement section 30 based on the determination. The announcement section 30 having received the announcement signal announces the motion of the user M1 using the announcement device. It is possible to monitor and then announce the motion of the user M1 using such a motion monitoring device 1.

Then, a configuration of the sensor section 10 will be explained. FIG. 2 is a block diagram showing a configuration of the sensor section 10. As shown in the drawing, the sensor section 10 is constituted by the acceleration detection section 11, a communication section 12, a storage section 13, an operation section 14, a control section 18, and so on.

The acceleration detection section 11 is a sensor for detecting a motion, namely the acceleration, of the user M1 attached with the sensor section 10. In the present embodiment, a motion (the acceleration) of the head of the user M1 in the seated state is detected by the sensor section 10, and then the detection data thus detected is transmitted to the information processing section 20. It should be noted that in the present embodiment, the acceleration detection section 11 is a sensor capable of detecting the acceleration in two-axis (x-axis and y-axis) directions. Further, the acceleration detection section 11 can also be a sensor capable of detecting the acceleration in three or more axis directions (a plurality of axis directions).

It should be noted that the acceleration detection section 11 will be described later.

The operation section 14 is provided with a filter circuit 14a such as a high-pass filter (HPF) for removing noise from the detection data of the acceleration, and an integration circuit 14b for integrating the detection data twice to thereby convert the detection data into displacement. In other words, the operating section 14 performs the process of removing noise from the detection data detected by the acceleration detection section 11 and converting the acceleration into the displacement (movement), and thus, the operation section 14 can obtain displacement information 13a as the movement of the sensor section 10, in other words, the movement of the head of the user M1. Then, the displacement information 13a is stored in the storage section 13.

The storage section 13 is an external storage device such as a hard disk drive, and stores a variety of data in the sensor section 10.

The communication section 12 is provided with a transmission section and a receiving section not shown and capable of communicating with the information processing section 20. The communication section 12 transmits the displacement information 13a, which can be obtained by the operation section 14, to the information processing section 20 via the communication section 12.

The control section 18 is provided with a central processing unit (CPU), a random access memory (RAM), a read-only memory (ROM), and so on not shown, and performs overall control of all sections of the sensor section 10.

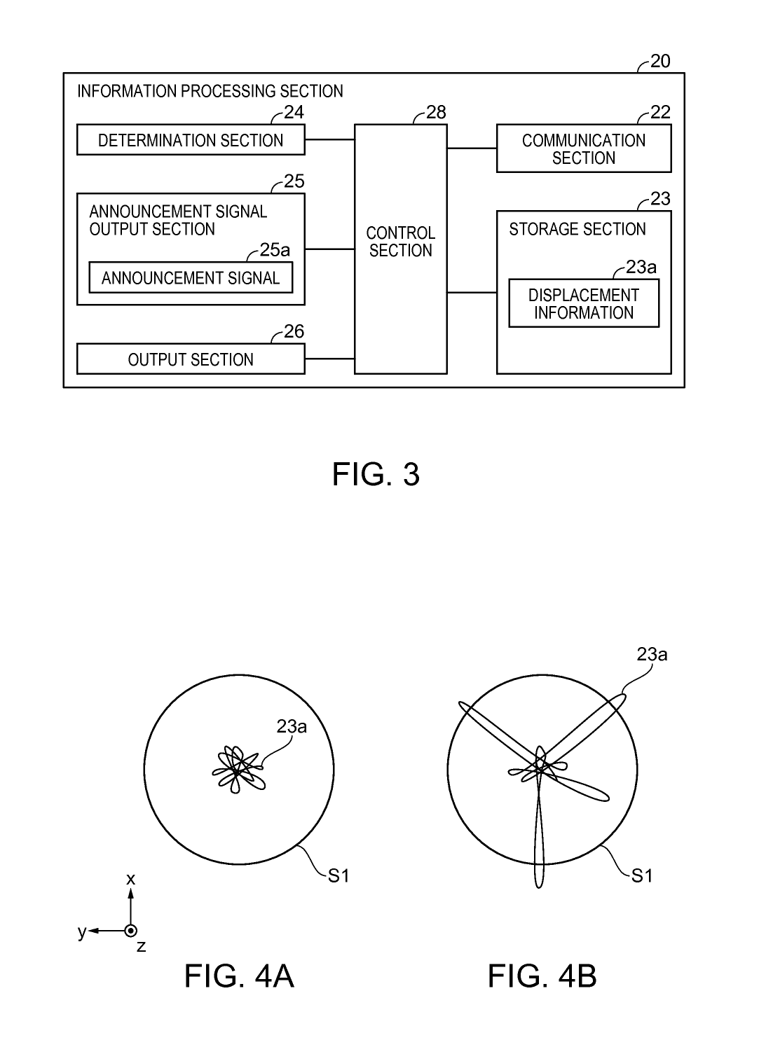

Then, a configuration of the information processing section 20 will be explained. FIG. 3 is a block diagram showing the configuration of the information processing section 20. As shown in the drawing, the information processing section 20 is constituted by a communication section 22, a storage section 23, a determination section 24, an announcement signal output section 25, an output section 26, a control section 28, and so on.

The communication section 22 is provided with a transmission section and a receiving section not shown and capable of communicating with the sensor section 10 and the announcement section 30. The communication section 22 receives the displacement information 13a having been transmitted from the sensor section 10, and then stores the displacement information 23a in the storage section 23 as displacement information 23a.

The storage section 23 is an external storage device such as a hard disk drive, and stores a variety of data in the information processing section 20.

The determination section 24 determines whether or not the displacement information 23a stored in the storage section 23 is within a range of a predetermined threshold value S1. In other words, whether the motion is present or absent is determined based on whether or not the position of the head of the user M1 is located within the range of the threshold value S1.

The threshold value S1 is set to have the inside of a roughly circular range formed in the x, y directions cantered on an origin of the displacement information 23a.

Here, an example of the determination on whether a motion of the user M1 is present or absent will be explained with reference to FIGS. 4A and 4B. FIGS. 4A and 4B are diagrams each showing an example of the displacement information 23a when viewing the sensor section 10 attached to the head of the user M1 not shown from the +z-axis direction. FIGS. 4A and 4B each show the movement of the displacement information 23a in x-axis and y-axis directions (the two-axis directions).

The determination section 24 determines whether a motion of the user M1 is present or absent using such displacement information 23a as shown in FIGS. 4A and 4B and the threshold value S1 as information for making the determination.

The determination section 24 determines that the motion of the user M1 is small (the motion is absent) if the displacement information 23a is within the range (inward direction of the roughly circular area) of the threshold value S1 (FIG. 4A), or determines that the motion of the user M1 is large (the motion is present) if the displacement information 23a is out of the range (outward direction of the roughly circular area) of the threshold value S1 (FIG. 4B). It should be noted that the setting of the range of the threshold value S1 can be changed by the user. For example, the user with a small motion of the sensor section 10 can set the range of the threshold value S1 to be narrow, and the user with a large motion of the sensor section 10 can set the range of the threshold value S1 to be broadened.

The announcement signal output section 25 transmits the announcement signal 25a to the announcement section 30 via the communication section 22. Specifically, in the case in which it is determined that the motion of the user M1 is large, namely the displacement information 23a described above exists outside the range of the threshold value S1, the announcement signal output section 25 transmits the announcement signal 25a to the announcement section 30 via the communication section 22.

Regarding the timing for transmitting the announcement signal 25a to the announcement section 30, the announcement signal 25a is transmitted when, for example, the number of times the displacement information 23a runs off the range of the threshold value S1, which is stored, reaches a predetermined value, or exceeds the predetermined value. Further, it is also possible to transmit the announcement signal 25a in the case in which the movement of the displacement information 23a is remarkably large.

The output section 26 displays the motion (FIGS. 4A and 4B) of the user M1 on a display or the like not shown based on the motion of the user M1. By displaying the motion, it is possible to make the user M1 recognize the motion of him or herself.

The control section 28 is provided with a CPU, a RAM, a ROM, and so on not shown, and integrally controls all of the sections of the information processing section 20.

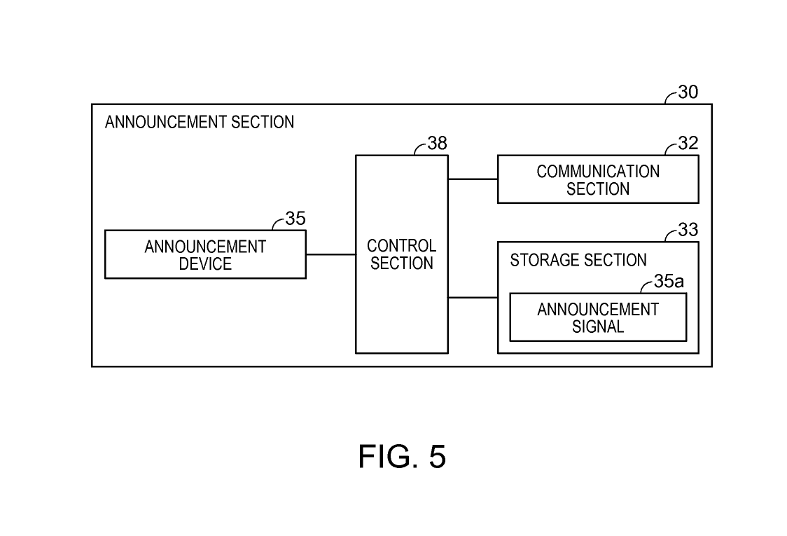

Then, a configuration of the announcement section 30 will be explained. FIG. 5 is a block diagram showing the configuration of the announcement section 30. As shown in the drawing, the announcement section 30 is constituted by a communication section 32, an announcement device 35, a storage section 33, a control section 38, and so on.

The communication section 32 is provided with a transmission section and a receiving section not shown and capable of communicating with the information processing section 20. The communication section 32 receives the announcement signal 25a having been transmitted from the information processing section 20, and then sets the announcement signal 25a as the announcement signal 35a. Then, the announcement signal 35a is stored in the storage section 33.

The announcement device 35 announces the fact that the motion (the displacement information) of the user M1 runs off the range of the threshold value S1 using a warning or a stimulus based on the announcement signal 35a. In the present embodiment, the announcement section 30 of the user M1 in the seated state shown in FIG. 1 is provided the announcement device 35 equipped with a vibration generator not shown and for making an announcement to the user M1 with a stimulus by a vibration.

The announcement device 35 can use a warning with a sound from a speaker installed in the announcement section 30, a warning with light or a picture using a display installed, or a warning with an electrical stimulus using, for example, so called low-frequency therapy equipment used in a physical therapy procedure. In other words, the announcement device can arbitrarily change the announcement method in accordance with the configuration of the announcement section 30.

It should be noted that the announcement section 30 for announcing the warning with the speaker, the display, or the like can be installed in the vicinity of the user M1.

Further, the warning with a sound can be arranged to represent the magnitude of the displacement with the scale varied in accordance with the magnitude. Further, it is also possible to arrange that the warning with a sound, a vibration, or the like is formed as pulses, and the magnitude of the displacement is represented by the width of the period of the pulses.

The storage section 33 is an external storage device such as a hard disk drive, and stores a variety of data in the announcement section 30.

The control section 38 is provided with a CPU, a RAM, a ROM, and so on not shown, and integrally controls all of the sections of the announcement section 30.

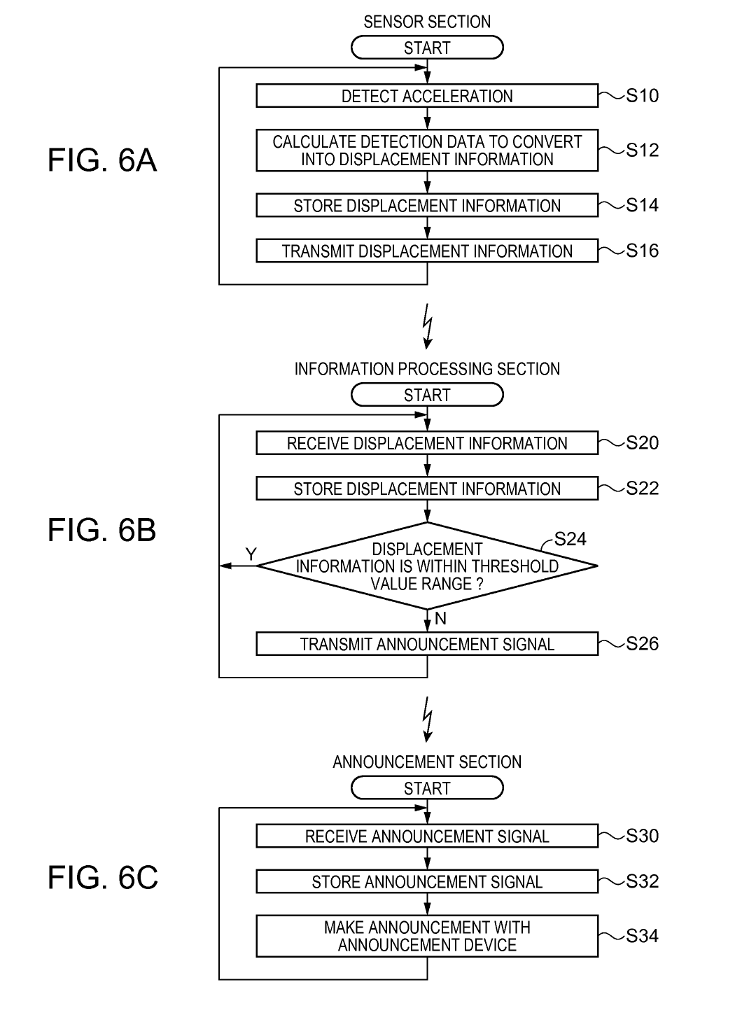

Then, processes in the sensor section 10, the information processing section 20, and the announcement section 30 constituting the motion monitoring device 1 will be explained. FIGS. 6A through 6C are flowcharts showing an example of the process of the motion monitoring device 1, wherein FIG. 6A is a diagram showing a flowchart for the sensor section 10, FIG. 6B is a diagram showing a flowchart for the information processing section 20, and FIG. 6C is a diagram showing a flowchart for the announcement section 30. Each of the processes of the sensor section 10, the information processing section 20, and the announcement section 30 shown in the drawings starts in the case in which a start switch not shown of the corresponding section is set to an ON state, and then ends in the case in which the switch is set to an OFF state. Hereinafter, the explanation will be presented with reference to FIGS. 2, 3, 5, and 6A through 6C.

As shown in FIG. 6A, the sensor section 10 firstly detects (step S10) the acceleration in the two-axis directions of the sensor section 10 using the acceleration detection section 11.

Then, the sensor section 10 removes the noise from the detection data detected in the step S10 using the filter circuit 14a of the operation section 14, and then integrates the detection data twice using the integration circuit 14b to thereby convert the detection data into the displacement information 13a (step S12).

Then, the sensor section 10 stores (step S14) the displacement information 13a converted in the step S12 in the storage section 13.

Then, the sensor section 10 transmits (step S16) the displacement information 13a converted in the step S12 to the information processing section 20 using the communication section 12.

Then, the sensor section 10 makes the transition of the process to the step S10 to repeat the process.

Then, as shown in FIG. 6B, the information processing section 20 receives (step S20) the displacement information 13a from the sensor section 10 using the communication section 22.

Then, the information processing section 20 stores (step S22) the displacement information 13a received in the step S20 in the storage section 23.

Then, the information processing section 20 determines (step S24) whether or not the displacement information 23a is within the range of the threshold value S1 using the determination section 24.

In the case in which the displacement information 23a is within the range of the threshold value S1 (Y in the step S24), the transition to the step S20 is made to repeat the process.

In contrast, in the case in which the displacement information 23a exceeds the range of the threshold value S1 (N in the step S24), the announcement signal output section 25 transmits (step S26) the announcement signal 25a to the announcement section 30 via the communication section, and the transition to the step S20 is made to repeat the process.

Then, as shown in FIG. 6C, the announcement section 30 receives (step S30) the announcement signal 25a from the information processing section 20 using the communication section 32.

Then, the announcement section 30 stores (step S32) the announcement signal 25a having been received in the step S30 in the storage section 33 as the announcement signal 35a.

Then, the announcement section 30 announces (step S34) the fact that the motion of the user M1 has exceeded the range of the threshold value S1 with a stimulus or a warning using the announcement device 35, and then the transition to the step S30 is made to repeat the process.

In the motion monitoring device 1 described above, the acceleration of the sensor section 10 is detected in the sensor section 10, then the acceleration is converted into the displacement information 13a, and then the displacement information 13a is transmitted to the information processing section 20. The information processing section 20 determines the displacement information 23a (13a) of the sensor section 10 based on a predetermined criterion (the range of the threshold value S1), and then transmits the announcement signal to the announcement section 30. The announcement section 30 can make an announcement based on the announcement signal received.

As described hereinabove, according to the motion monitoring device 1 related to the first embodiment, the following advantages can be obtained.

According to the first embodiment, if the detection data (the displacement information) detected by the sensor section 10 attached to the user M1 exceeds the range of the threshold value S1, the motion monitoring device 1 can make an announcement to the user M1.

According to the motion monitoring device 1, the device can be decreased in size, and has portability since the sensor section 10 can be attached to at least (either) one of the body of the user M1 and the worn item (a cap or a hat, and clothing not shown) of the user M1, and thus convenience is enhanced.

Although in the first embodiment, it is assumed that the motion monitoring device 1 detects and then determines a motion of the user M1 to make an announcement using the announcement device 35, it is also possible to use the motion monitoring device 1 for, for example, Zazen meditation.

In Zazen meditation, it is known that if a worldly thought enters the mind, distraction of the mind occurs, and thus breathing is disturbed, the head (or the body) moves, and hitting with a warning Zen stick is performed. Therefore, by attaching the sensor section 10 to the head of the user M1 (a beginner of Zazen) in Zazen meditation, it becomes possible to monitor the motion (the displacement information) of the head of the user M1, and make an announcement with the announcement device 35 as if hitting with the warning Zen stick were performed in the case in which the motion has exceeded the range of the threshold value S1. It should be noted that the range of the threshold value S1 can be changed, and by broadening (lowering the difficulty level) or narrowing (raising the difficulty level) the range, the difficulty level of Zazen can be changed.

Further, it is also possible to store the displacement information of a so-called Zazen expert, and display the displacement information of the Zazen expert and the displacement information of the user M1 on a display not shown. Thus, the motions in Zazen meditation of the respective cases can be compared with each other, and thus, it is possible to strive to improve the Zazen meditation.

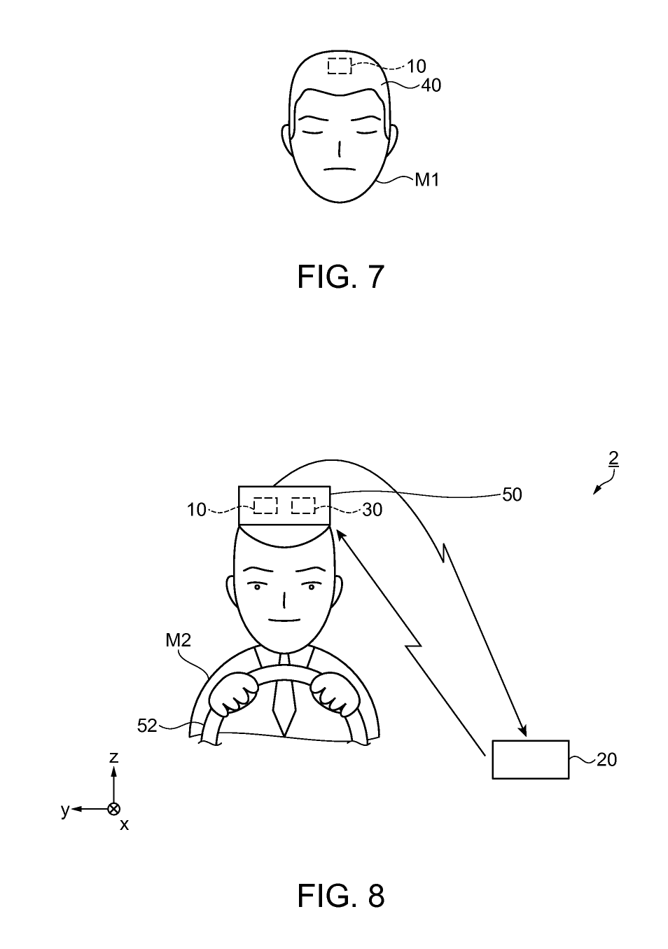

FIG. 7 is a diagram showing an example of a worn item attached with the sensor section 10. As shown in FIG. 7, the user M1 uses the worn item 40 (a so-called shaven head wig) attached with the sensor section 10. Thus, it is possible for the user M1 to perform Zazen meditation in a mood of being a Buddhist monk or an ascetic monk.

Further, it is possible for the user M1 to easily perform Zazen meditation anywhere by using the motion monitoring device 1 having portability.

### Second Embodiment

FIG. 8 is a diagram showing a configuration example of a motion monitoring device 2 according to a second embodiment. In FIG. 8, an x axis, a y axis, and a z axis are shown as three axes perpendicular to each other.

A configuration of the motion monitoring device 2 according to the present embodiment will be explained with reference to FIG. 8. Since the motion monitoring device 2 has a similar schematic configuration to that of the motion monitoring device 1 according to the first embodiment shown in FIG. 1, the same constituents as those of the first embodiment will be denoted with the same reference symbols, and the explanation thereof will be omitted or simplified here.

The motion monitoring device 2 is configured including the sensor section 10 and the announcement section 30 attached to a cap 50 worn by the user M2 as a test subject engaged in a driving operation of a vehicle, and the information processing section 20 attached to the vehicle not shown. The motion monitoring device 2 can detect the motion of the cap 50, namely the head of the user M2, from a motion of the sensor 10. The user M2 grips a steering wheel 52 for controlling the vehicle. It should be noted that although the driving operation of the vehicle is explained in the present embodiment, there can also be cited a driving operation of, for example, a car, a train, a ship, a boat, or an aircraft.

In the motion monitoring device 2, a motion of the user M2 is detected using an acceleration detection section 11a provided to the sensor section 10, and then the detection data thus detected is transmitted to the information processing section 20. Then, in the information processing section 20, whether a motion of the user M2 is present or absent is determined based on the detection data thus received, and then, for example, display on a display not shown is performed, an announcement signal is transmitted to the announcement section 30, or an announcement to an operation management section not shown is made using a communication section. Thus, the information processing section 20 can monitor the motion of the user M2.

In the present embodiment, the acceleration detection section 11a of the sensor section 10 (see FIG. 2) is a sensor for detecting a motion, namely the acceleration, of the user M2. In the present embodiment, the motion of the head of the user M2 is measured by the sensor section 10. It should be noted that the acceleration detection section 11a is a sensor capable of detecting the acceleration along the three axes (the x axis, the y axis, and the z axis). Further, the acceleration detection section 11a can also be a sensor capable of detecting the acceleration along more than three axes (a plurality of axes).

It should be noted that the acceleration detection section 11a will be described later.

The storage section 23 of the information processing section 20 (see FIG. 3) continuously stores the motion of the user M2 when driving the vehicle as the displacement information 23a. Then, the determination section 24 determines whether or not the latest displacement information 23a (13a) having been transmitted from the sensor section 10 is within the range of the threshold value. In other words, the determination section 24 determines whether or not the motion of the head of the user M2 is within the range of the threshold value.

The threshold value of the present embodiment denotes a value obtained by adding a predetermined allowable amount to the displacement information 23a having been stored in the storage section 23 prior to the latest displacement information 23a.

Here, an example of the determination on whether a motion of the user M2 is present or absent will be explained. The determination section 24 determines a motion of the user M2 using the displacement information 23a and the threshold value as information for making the determination. The determination section 24 determines that the motion of the user M2 is small (the motion is absent) if the displacement information 23a is within the range of the threshold value, or determines that the motion of the user M2 is large (the motion is present) if the displacement information 23a is out of the range of the threshold value. In the case in which, for example, the motion of the head of the user M2 is large, it is conceivable that there is a sign of drowsy driving, or the user M2 is asleep at the wheel.

In the case in which it is determined that the motion of the user M2 is large, namely there is a sign of drowsy driving or the user M2 is asleep at the wheel, the announcement signal output section 25 transmits the announcement signal 25a to the announcement section 30 via the communication section 22.

Regarding the timing for transmitting the announcement signal 25a to the announcement section 30, the announcement signal 25a is transmitted when, for example, the number of times the displacement information 23a runs off the range of the threshold value, which is stored, reaches a predetermined value, or exceeds the predetermined value. Further, it is also possible to transmit the announcement signal 25a when the movement of the displacement information is remarkably large.

It is possible for the output section 26 to display a warning message on a display not shown or the like based on the motion of the user M2 to thereby prompt the user M2 to awaken.

Further, the information processing section 20 receives a signal from GPS satellites via a GPS receiver not shown, then analyzes a navigation message included in the signal thus received to thereby perform a positioning process, and thus obtains positional information. The information processing section 20 can also transmit the warning message, the positional information described above, and so on to an operation management center not shown at the timing when the announcement signal 25a is transmitted to the announcement section 30. Thus, it is possible for the manager of the operation management center to figure out the situation of the vehicle the user M2 is driving.

The communication section 32 of the announcement section 30 (see FIG. 5) is provided with a transmission section and a receiving section not shown and capable of communicating with the information processing section 20. The communication section 32 receives the announcement signal 25a having been transmitted from the information processing section 20, and then sets the announcement signal 25a as the announcement signal 35a.

The announcement device 35 can make an announcement with a warning or a stimulus in order to prompt the user M2 to awaken from drowsy driving based on the announcement signal 35a. In the example shown in FIG. 8, the announcement device 35 (the announcement section 30) is attached to the cap 50 worn by the user M2. In the present embodiment, the announcement section 30 is provided with the announcement device 35 equipped with a vibration generator not shown and for making an announcement to the user M2 with a stimulus due to the vibration.

As the announcement device 35, there can be cited a system having, for example, a speaker installed in the announcement section 30, and making an announcement with a warning by a sound. In other words, the announcement device can arbitrarily change the announcement method in accordance with the configuration of the announcement section 30.

It should be noted that there is a possibility that due to the announcement device 35 suddenly applying a warning using a sound or a stimulus using a vibration in order to prompt the user M2 to awaken, the user M2 is startled to pose a problem for the driving operation. Therefore, it is possible to begin the announcement such as a warning or a stimulus with a low level and then gradually increase the level of the announcement.

Further, in the case in which the displacement information 23a remains out of the range of the threshold value even after the user M2 is prompted to awaken by the announcement device 35, it is possible to stop the vehicle with a vehicle automatic stopping device not shown. It should be noted that the explanation of the vehicle automatic stopping device will be omitted.

As described hereinabove, according to the motion monitoring device 2 related to the second embodiment, the following advantages can be obtained.

According to the second embodiment, the motion monitoring device 2 has the sensor section 10 attached to the cap 50 worn by the user M2, and takes out the displacement information 13a from the motion of the cap 50. Then, the motion monitoring device 2 transmits the displacement information 13a to the information processing section 20 to determine whether or not the displacement information 23a (13a) is within the range of the threshold value. It is possible for the motion monitoring device 2 to determine that the drowsy driving is in progress, and prompt the user M2 to awaken using the announcement device 35 if the displacement information 23a is out of the range of the threshold value, and thus inhibit an accident while driving the vehicle.

According to the motion monitoring device 2, since the device can be decreased in size, and has portability, the sensor section 10 and the announcement section 30 can be attached to the cap 50 of the user M2, and thus the motion monitoring device 2 can be worn without posing a problem in driving a vehicle.

### Third Embodiment

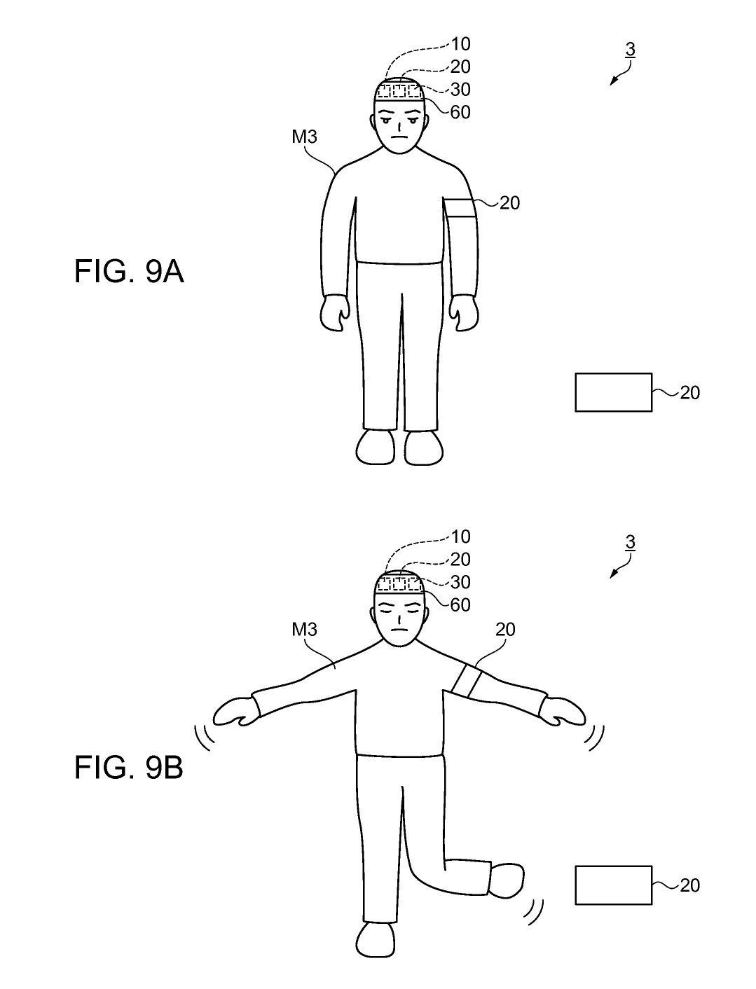

FIGS. 9A and 9B are diagrams showing a configuration example of a motion monitoring device 3 according to a third embodiment. A configuration of the motion monitoring device 3 according to the present embodiment will be explained with reference to FIGS. 9A and 9B. Since the motion monitoring device 3 has a similar schematic configuration to that of the motion monitoring device 1 according to the first embodiment shown in FIG. 1, the same constituents as those of the first embodiment will be denoted with the same reference symbols, and the explanation thereof will be omitted or simplified here.

The motion monitoring device 3 is configured including the sensor section 10, the announcement section 30, and the information processing section 20.

The sensor section 10 and the announcement section 30 are attached to the worn item 60, and the information processing section 20 is disposed in either of the worn item 60, the user M3 as a test subject, and the vicinity of the user M3. It should be noted that FIGS. 9A and 9B show an arrangement example of the information processing section 20.

The worn item. 60 has a shape of a ring-like headband to be mounted on the head. Further, a so-called Alice band (a clothing accessory for holding the hair) having a horseshoe shape, and a strip-shaped headband can also be adopted although not shown.

The user M3 wears the worn item 60 on the head, and the sensor section 10 can detect a motion of the head of the user M3.

In the motion monitoring device 3, a motion of the user M3 is detected using an acceleration detection section 11 provided to the sensor section 10, and then the detection data thus detected is transmitted to the information processing section 20. Then, in the information processing section 20, whether the motion of the user M3 is present or absent is determined based on the detection data thus received, and then, for example, display on a display not shown is performed, or an announcement signal is transmitted to the announcement section 30. Thus, the information processing section 20 can monitor a motion of the user M3.

In the present embodiment, the acceleration detection section 11 of the sensor section 10 (see FIG. 2) is a sensor for detecting a motion, namely the acceleration, of the user M3. In the present embodiment, a motion of the head of the user M3 is measured by the sensor section 10. It should be noted that the acceleration detection section 11 is a sensor capable of detecting the acceleration along two axes (the x axis and the y axis). Further, the acceleration detection section 11 can also be a sensor capable of detecting the acceleration along three or more axes (a plurality of axes).

The storage section 23 of the information processing section 20 (see FIG. 3) continuously stores the motion of the user M3 as the displacement information 23a. Then, the determination section 24 determines whether or not the latest displacement information 23a (13a) having been transmitted from the sensor section 10 is within the range of the threshold value. In other words, the determination section 24 determines whether or not the motion of the head of the user M3 is within the range of the threshold value.

The threshold value of the present embodiment denotes a value obtained by adding a predetermined allowable amount to the displacement information 23a having been stored in the storage section 23 prior to the latest displacement information 23a.

Here, an example of the determination on whether a motion of the user M3 is present or absent will be explained. As shown in FIG. 9A, in the case in which the user M3 has a standing posture and is in a stable state, namely in the case in which the displacement information 23a is within the range of the threshold value, the determination section 24 determines that the movement of the user M3 is small (the movement is absent). Further, as shown in FIG. 9B, in the case in which the user M3 has a posture with one foot lifted and the eyes closed, and is in an unstable state, namely in the case in which the displacement information 23a is out of the range of the threshold value, the determination section 24 determines that the movement of the user M3 is large (the movement is present).

For example, in the case in which the motion of the user M3 is large, it is conceivable that the user M3 stands shakily.

In the case in which it is determined that the motion of the user M3 is large, namely the user M3 stands shakily, the announcement signal output section 25 transmits the announcement signal 25a to the announcement section 30 via the communication section 22.

Regarding the timing for transmitting the announcement signal 25a to the announcement section 30, the announcement signal 25a is transmitted when, for example, the number of times the displacement information 23a runs off the range of the threshold value, which is stored, reaches a predetermined value, or exceeds the predetermined value. Further, it is also possible to transmit the announcement signal 25a when the movement of the displacement information 23a is remarkably large.

It is possible for the output section 26 to display a message or a figure on a display not shown or the like based on the motion of the user M3 to thereby inform the user M3 or other users of the wobble or the time until the wobble begins.

The communication section 32 of the announcement section 30 (see FIG. 5) is provided with a transmission section and a receiving section not shown and capable of communicating with the information processing section 20. The communication section 32 receives the announcement signal 25a having been transmitted from the information processing section 20, and then sets the announcement signal 25a as the announcement signal 35a.

The announcement device 35 can announce the wobble of the user M3 with a warning or a stimulus based on the announcement signal 35a. In the example shown in FIGS. 9A and 9B, the announcement section 30 is attached to the worn item 60 worn by the user M3, and the announcement section 30 is provided with the announcement device 35 equipped with a vibration generator not shown and for making an announcement to the user M3 with a stimulus due to the vibration.

As the announcement device 35, there can be cited a system having, for example, a speaker installed in the announcement section 30, and making an announcement with a warning by a sound. It is also possible for the announcement section 30 to output a sound with the scale varied in accordance with the direction of the wobble or a sound with the volume varied in accordance with the magnitude of the wobble from the speaker. Further, it is also possible to use the motion monitoring device 3 as a musical instrument for carrying the melody by controlling the scale and the volume in accordance with the intentional motion of the head of the user.

The announcement device 35 can arbitrarily change the announcement method in accordance with the configuration of the announcement section 30.

As described hereinabove, according to the motion monitoring device 3 related to the third embodiment, the following advantages can be obtained.

According to the third embodiment, the motion monitoring device 3 has the sensor section 10 attached to the worn item 60 worn by the user M3, and takes out the displacement information 13a from the motion of the worn item 60.

Then, the motion monitoring device 3 transmits the displacement information 13a to the information processing section 20 to determine whether the motion (wobble) is present or absent based on whether or not the displacement information 23a (13a) is within the range of the threshold value. If the displacement information 23a is out of the range of the threshold value, it is determined that the wobble is present, and it is possible to call the attention of the user M3 with the announcement device 35.

Further, the motion monitoring device 3 can determine the wobble, and can therefore be applied to a game of keeping the balance, and training for improving balance. Further, by performing numerical determination on the wobble, it is possible to apply the motion monitoring device 3 to the diagnosis of a disease having a case of wobble, a wobble check when performing a walk test of a driver of a vehicle or the like in a balloon test (an alcohol test), and so on.

The motion monitoring device 3 is capable of monitoring the motion (the wobble) and then making an announcement with constituents small in size and number, and can therefore be reduced in size, provided with portability, and improved in convenience.

### MODIFIED EXAMPLES

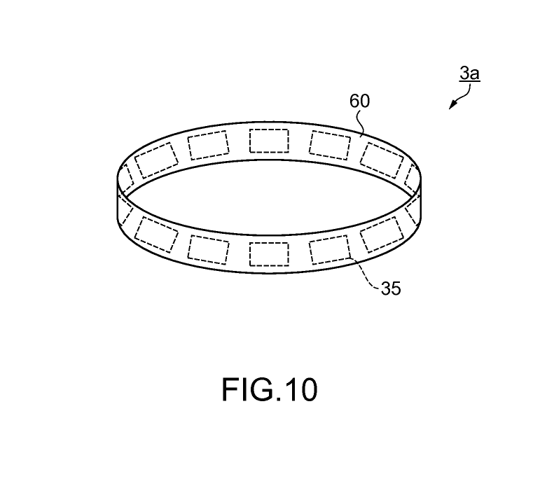

FIG. 10 is a perspective view showing a configuration example of a motion monitoring device 3a according to a modified example. The motion monitoring device 3a is configured including the sensor section 10, the information processing section 20, and the announcement section 30, and the sensor section 10 and the announcement section 30 are attached to the worn item 60. It should be noted that in FIG. 10, the sensor section 10, the information processing section 20, and the announcement section 30 are omitted from the drawing.

In the present modified example, the announcement section 30 is provided with the announcement device 35 equipped with a vibration generator not shown and for making an announcement to the user with a stimulus due to the vibration. As shown in FIG. 10, a plurality of announcement devices 35 is disposed on the worn item 60 in a certain arrangement along the circumferential direction.

When the user wears the worn item 60 on the head, by vibrating the announcement device 35 disposed at the position in the same direction as the direction of the motion of the head of the user detected by the sensor section 10, it is possible to inform the user wearing the worn item 60 of the direction in which the user is wobbling.

### Acceleration Detection Section

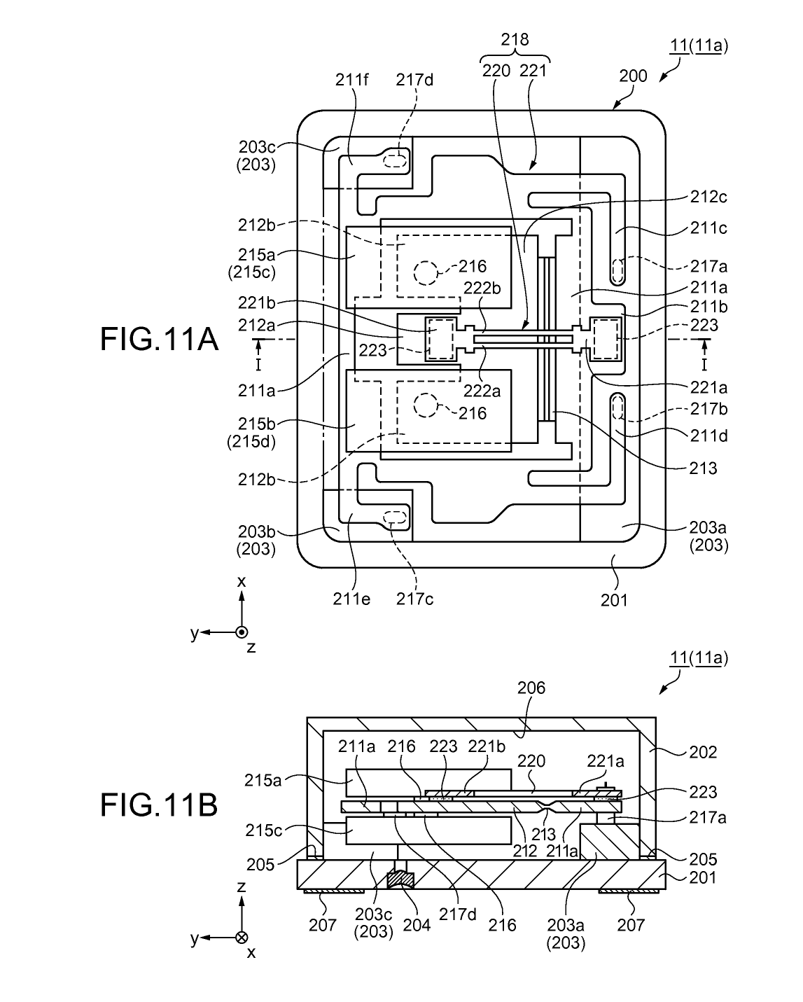

The acceleration detection section 11 (11a) related to the embodiments described above will be explained. FIG. 11A is a plan view showing a configuration of the acceleration detection section 11 (11a). FIG. 11B is a cross-sectional view showing the configuration of the acceleration detection section 11 (11a), and shows the cross-sectional surface along the I-I line shown in FIG. 11A. Further, in FIGS. 11A and 11B, the x axis, the y axis, and the z axis are shown as three axes perpendicular to each other. It should be noted that in the plan view, a lid 202 is omitted from the drawing for the sake of convenience of explanation.

As shown in FIGS. 11A and 11B, the acceleration detection section 11 (11a) is provided with a package 200 and a physical quantity detection sensor 218 including an element base body 221 and a pressure-sensitive element 220.

Firstly, the package 200 is formed of a package base 201 and the lid 202. The package base 201 is a flat plate having a quadrangular shape in a planar view viewed from the +z-axis direction.

The package base 201 has step sections 203 for fixing the element base body 221 of the physical quantity detection sensor 218, and the step sections 203 correspond to a step section 203a disposed along the x axis in one of end portions in the y-axis direction, and step sections 203b, 203c respectively disposed in the vicinities of two corner portions in the other of the end portions in the y-axis direction.

Further, the package base 201 has a sealing section 204 formed of a hole penetrating the flat plate and a sealing member for blocking the hole, and external terminals 207, which are formed on a surface on the opposite side to the surface on which the step sections 203a, 203b, and 203c are disposed, and are used to be connected to an external oscillator circuit and so on.

The package base 201 is formed of an aluminum oxide sintered body obtained by calcining a ceramic green sheet. The aluminum oxide sintered body of ceramic is superior in the package use, but is an unworkable material. However, in this case, the package base 201 has a flat plate shape, and can therefore be formed easily compared to the case of forming the package base 201 to have a shape other than the flat plate shape. It should be noted that the package base 201 can also be formed using a material such as a quartz crystal, glass, or silicon.

The lid 202 has a housing section 206 formed to have a recessed shape toward an inward direction, and is disposed so as to cover the pressure-sensitive element 220 using the step sections 203a, 203b, and 203c of the package base 201 as guides, and is fixed to the package base 201.

As the material of the lid 202, there can be used the same material as that of the package base 201, and metal such as kovar, or stainless steel, and here, there is used kovar, with which the housing section 206 can more easily be formed compared to ceramic. Further, the lid 202 can seal the housing section 206 in, for example, an airtight state with reduced pressure when bonded to the package base 201 via a seam ring 205.

Here, sealing of the housing section 206 is performed using a method of bonding the package base 201 and the lid 202 to each other, then evacuating the air in the housing section 206 from the hole of the sealing section 204 to thereby form a reduced pressure state, and then blocking the hole with a brazing material (a sealing material). Thus, the physical quantity detection sensor 218 is encapsulated inside the housing section 206 in the airtight state with reduced pressure. It should be noted that the inside of the housing section 206 can be filled with an inert gas such as nitrogen, helium, or argon.

The physical quantity detection sensor 218 includes the element base body 221 fixed to the package base 201, and the pressure-sensitive element 220 fixed to the element base body 221 and for detecting the physical quantity such as a vibration. The element base body 221 is formed from a quartz crystal plate by etching or the like, and has a plate-like shape located along the x-y plane. The element base body 221 has a stationary section (a base section) 211 (211a through 211f) having a roughly quadrangular ring-like shape in a planar view, a movable section 212 (212a through 212c) disposed inside (inside the ring-like shape) of the stationary section 211, and a joint section 213 connecting the stationary section 211 and the movable section 212 to each other.

The stationary section 211 has a frame section 211a having a ring-like shape along the x axis and the y axis, an element mounting section 211b projecting outward along the y axis from the center of one of sides of the frame section 211a extending along the x axis, an arm section 211c branching from one of sides of the frame section 211a extending along the y axis, and extending to the vicinity of the element mounting section 211b along the outer circumference of the frame section 211a, an arm section 211d branching from the other of the sides of the frame section 211a extending along the y axis, and extending to the vicinity of the element mounting section 211b along the outer circumference of the frame section 211a, an arm section 211e branching from the other of the sides of the frame section 211a extending along the x axis, and extending to the vicinity of the branching portion of the arm section 211d along the outer circumference of the frame section 211a, and an arm section 211f branching from the other of the sides of the frame section 211a extending along the x axis, and extending to the vicinity of the branching portion of the arm section 211c along the outer circumference of the frame section 211a.

The arm sections 211c, 211d, 211e, and 211f are regions for fixing the element base body 221 to the package base 210, a tip portion of the arm section 211c is fixed to the step section 203a via a support section 217 (217a) (FIGS. 11A and 11B), a tip portion of the arm section 211d is fixed to the step section 203a via the support section 217 (217b), a tip portion of the arm section 211e is fixed to the step section 203b via the support section 217 (217c), and a tip portion of the arm section 211f is fixed to the step section 203c via the support section 217 (217d). The support sections 217 are each an adhesive in this case, and fix the whole of the stationary section 211 to the step sections 203 via the arm sections 211c, 211d, 211e, and 211f in a state of providing a predetermined gap.

The movable section 212 (212a through 212c) is surrounded by the frame section 211a and is connected to the frame section 211a provided with the element mounting section 211b via the joint section 213.

In other words, the movable section 212 is in the state of being cantilevered to the frame section 211a by the joint section 213 Then, the movable section 212 has an element mounting section 212a extending along the y axis toward an opposite direction to the joint section 213, and mass body mounting sections 212b disposed on the both sides of the element mounting section 212a, and each extending along the y axis. It should be noted here that the surface of the movable section 212 on which the pressure-sensitive element 220 is mounted is referred to as a principal surface 212c.

Further, on each of the mass body mounting sections 212b of the movable section 212, there are disposed mass bodies 215 each functioning as a weight. The mass bodies 215 (215a through 215d) include the mass body 215a disposed on the principal surface 212c side of one of the mass body mounting sections 212b, the mass body 215c disposed on a surface on the opposite side to the principal surface 212c so as to overlap the mass body 215a in a planar view, the mass body 215b disposed on the principal surface 212c side of the other of the mass body mounting sections 212b, and the mass body 215d disposed on a surface on the opposite side to the principal surface 212c so as to overlap the mass body 215b in a planar view. These mass bodies 215 are fixed to the movable section 212 via bonding sections 216, and in this case, the bonding sections 216 are each an adhesive disposed at the centroid position of the mass body 215, and fix the mass body 215 and the movable section 212 to each other in a state of providing a predetermined gap.

Further, the pressure-sensitive element 220 has a base section 221a to be fixed to the element mounting section 211b of the stationary section 211 with an adhesive 223, a base section 221b fixed to the element mounting section 212a of the movable section 212 with an adhesive 223, and vibrating beams 222 (222a, 222b) located between the base section 221a and the base section 221b, and for detecting the physical quantity. In other words, the pressure-sensitive element 220 is connected to the stationary section (a base section) 211 and the movable section 212, and is disposed so as to stride over the joint section 213. In this case, the vibrating beam sections 222 each have a prismatic shape, and when a drive signal (an alternating voltage) is applied to excitation electrodes (not shown) respectively disposed to the vibrating beam sections 222a, 222b, the vibrating beam sections 222 vibrate in a flexural mode so as to get away from each other and come closer to each other along the x axis.

The excitation electrodes are electrically connected to the external terminals 207 with wiring not shown for applying the drive signal.

The pressure-sensitive element 220 is formed by patterning a crystal substrate, which has been carved out from a raw stone of the crystal at a predetermined angle, using a photolithography process and the etching process. By forming the pressure-sensitive element 220 using the quartz crystal, which is a material having the same nature as that of the element base body 221 as described above, the difference in linear expansion coefficient between the pressure-sensitive element 220 and the element base body 221 can preferably be made smaller. This can also be applied to the case of forming the pressure-sensitive element 220 and the element base body 221 using other materials than the quartz crystal.

Then, an operation of the physical quantity detection sensor 218 will be explained. As shown in FIG. 11B, when a physical quantity such as a vibration is applied to the physical quantity detection sensor 218 in, for example, the +z direction (a direction intersecting with the principal surface 212c), a force acts on the movable section 212 in the −z direction, and the movable section 212 is displaced in the −z direction taking the joint section 213 as a pivot point. Thus, a force in the direction in which the base section 221a and the base section 221b get away from each other along the y axis is applied to the pressure-sensitive element 220, and a tensile stress is generated in the vibrating beam sections 222 of the pressure-sensitive element 220. Therefore, the resonant frequency at which the vibrating beam sections 222 vibrates is raised.

In contrast, when a physical quantity such as a vibration is applied to the physical quantity detection sensor 218 in, for example, the −z direction (a direction intersecting with the principal surface 212c), a force acts on the movable section 212 in the +z direction, and the movable section 212 is displaced in the +z direction taking the joint section 213 as a pivot point. Thus, a force in the direction in which the base section 221a and the base section 221b come closer to each other along the y axis is applied to the pressure-sensitive element 220, and a compressive stress is generated in the vibrating beam sections 222 of the pressure-sensitive element 220. Therefore, the resonant frequency of the vibrating beam sections 222 is lowered.

The entire disclosure of Japanese Patent Application No. 2013-223007, filed Oct. 28, 2013 is expressly incorporated by reference herein.

What is claimed is:

1. A motion monitoring device comprising:
a detection section attached to a test subject, and adapted to detect a motion of the test subject:
a determination section adapted to determine whether or not displacement information of the test subject obtained based on a detection data from the detection section exceeds a threshold value; and
an announcement section adapted to make an announcement to the test subject based on the determination.

2. The motion monitoring device according to claim 1, further comprising:
an announcement signal output section adapted to transmit an announcement signal to the announcement section based on a determination result from the determination section,
wherein the announcement section makes an announcement to the test subject based on the announcement signal.

3. The motion monitoring device according to claim 1, further comprising:
an operation section adapted to calculate the displacement information based on acceleration,
wherein the detection section is capable of detecting acceleration, and
the operation section calculates the displacement information of the test subject based on the acceleration detected by the detection section.

4. The motion monitoring device according to claim 3, wherein
the operation section calculates the displacement by integrating the acceleration.

5. The motion monitoring device according to claim 1, wherein
the determination section compares the displacement information measured and the displacement information of the test subject having previously been measured with each other, and determines based on a result of the comparison.

6. The motion monitoring device according to claim 1, wherein
the detection section is mounted to a worn item to be worn by the test subject.

7. A motion monitoring device comprising:
an acceleration detection section adapted to detect acceleration of a predetermined region of a body of a test subject;
an operation section adapted to calculate displacement information of the predetermined region based on the acceleration;
a determination section adapted to determine whether or not the displacement information of the predetermined region exceeds a threshold value; and
an announcement section adapted to make an announcement to the test subject based on the determination.
